(19) United States
(12) Patent Application Publication
(10) Pub. No.: US 2024/0072350 A1
(43) Pub. Date: Feb. 29, 2024

(54) BATTERY PACK

(71) Applicant: Yazaki Corporation, Tokyo (JP)

(72) Inventor: Kimitoshi Makino, Shizuoka (JP)

(21) Appl. No.: 18/456,139

(22) Filed: Aug. 25, 2023

(30) Foreign Application Priority Data
Aug. 30, 2022 (JP) 2022-136536

(51) Int. Cl. H01M 50/213; H01M 50/507; H01M 50/519

(52) U.S. Cl. CPC H01M 50/213; H01M 50/507; H01M 50/519

(57) ABSTRACT

A battery pack includes a plurality of batteries having a cylindrical shape, arranged with outer circumferential surfaces of the batteries facing each other, and each of the batteries including electrodes on both ends in an axial direction thereof, a plurality of bus bars fixed to the electrodes, and a flexible printed wiring board including a plurality of conductors connected to the bus bars. The flexible printed wiring board includes a belt-like main body routed along the outer circumferential surfaces of the batteries, and branch portions projecting from the main body and connected to the bus bars.

### CROSS-REFERENCE TO RELATED APPLICATION(S)

The present application claims priority to and incorporates by reference the entire contents of Japanese Patent Application No. 2022-136536 filed in Japan on Aug. 30, 2022.

### BACKGROUND OF THE INVENTION

### 1. Field of the Invention

The present invention relates to a battery pack.

### 2. Description of the Related Art

In conventional art, there are battery packs including cylindrical batteries. Japanese Patent Application Laid-open No. 2016-178069 discloses a battery pack in which a battery module includes a plurality of cylindrical batteries and a battery holder formed of heat-transferable material. In the battery pack of Japanese Patent Application Laid-open No. 2016-178069, a cathode bus bar to be connected to upper electrodes (cathodes) of the cylindrical batteries is mounted on the upper side of holes in a cover.

In battery packs including cylindrical batteries, it is desired to simplify the routing structure. For example, in a structure in which bus bars are fixed to electrodes, it is desirable that voltage detection lines can be routed while suppressing interference with the bus bars.

### SUMMARY OF THE INVENTION

An object of the present invention is to provide a battery pack capable of simplifying the routing structure.

In order to achieve the above mentioned object, a battery pack according to one aspect of the present invention includes a plurality of batteries having a cylindrical shape, arranged with outer circumferential surfaces of the batteries facing each other, and each of the batteries including electrodes on both ends in an axial direction thereof; a plurality of bus bars fixed to the electrodes; and a flexible printed wiring board including a plurality of conductors connected to the bus bars, wherein the flexible printed wiring board includes a belt-like main body routed along the outer circumferential surfaces of the batteries, and branch portions projecting from the main body and connected to the bus bars.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a battery pack according to an embodiment;

FIG. 2 is a perspective view of a substrate module according to the embodiment;

FIG. 3 is a plan view of a flexible printed wiring board according to the embodiment;

FIG. 4 is a perspective view of a holding member according to the embodiment;

FIG. 5 is a perspective view illustrating a mount process of the substrate module to a battery module;

FIG. 6 is a plan view of the battery pack according to the embodiment;

FIG. 7 is a perspective view of the battery pack according to the embodiment;

FIG. 8 is a plan view of the battery pack according to the embodiment; and

FIG. 9 is a plan view of a bus bar module according to the embodiment.

### DETAILED DESCRIPTION OF THE PREFERRED EMBODIMENTS

The following is a detailed explanation of a battery pack according to an embodiment of the present invention, with reference to the drawings. The present invention is not limited to the embodiment. Constituent elements in the following embodiment include those that can be easily conceived by the skilled person or are substantially the same.

### EMBODIMENT

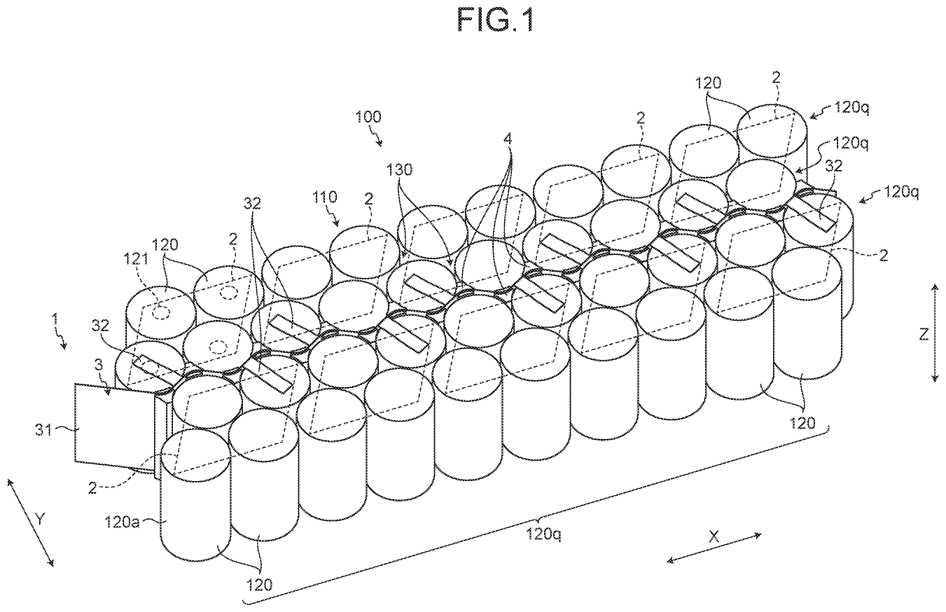

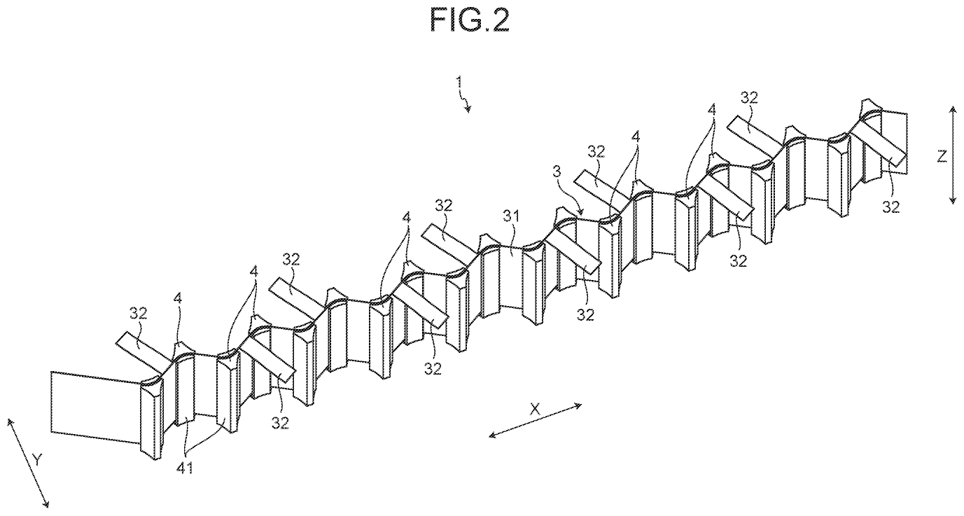

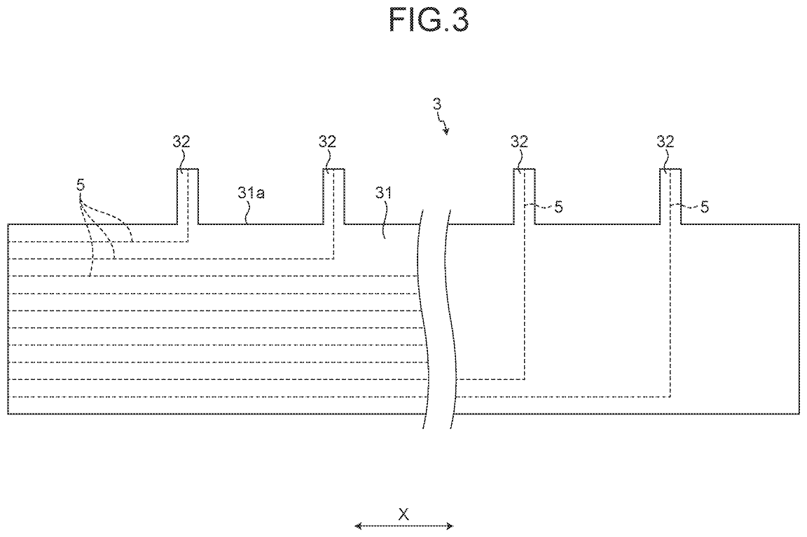

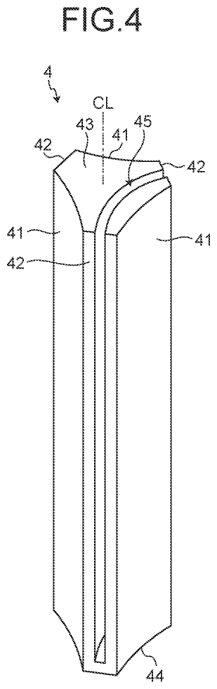

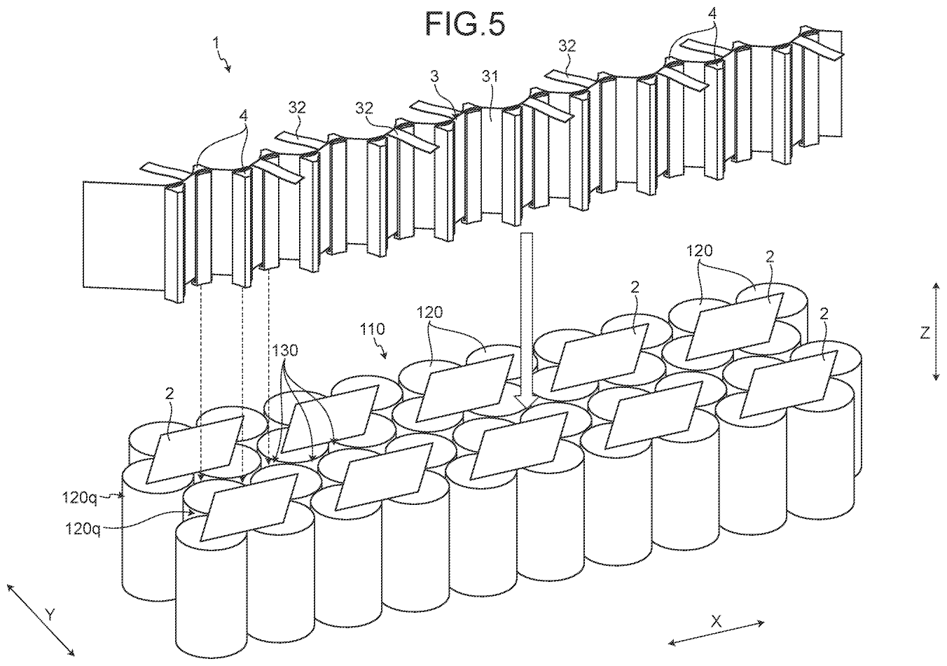

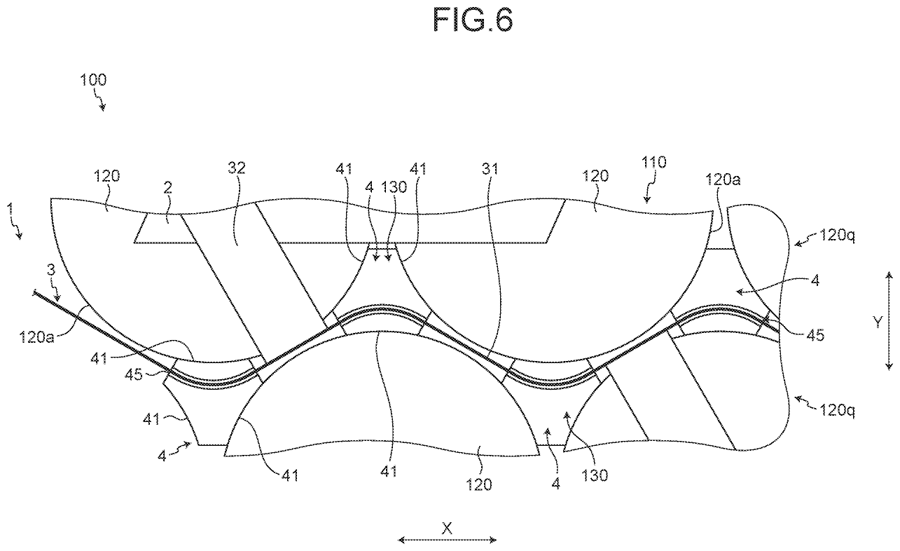

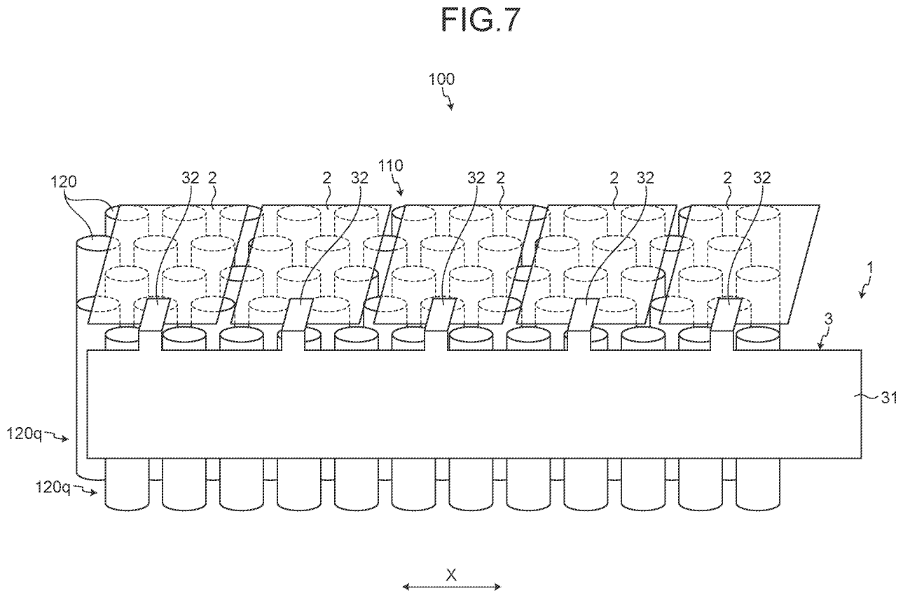

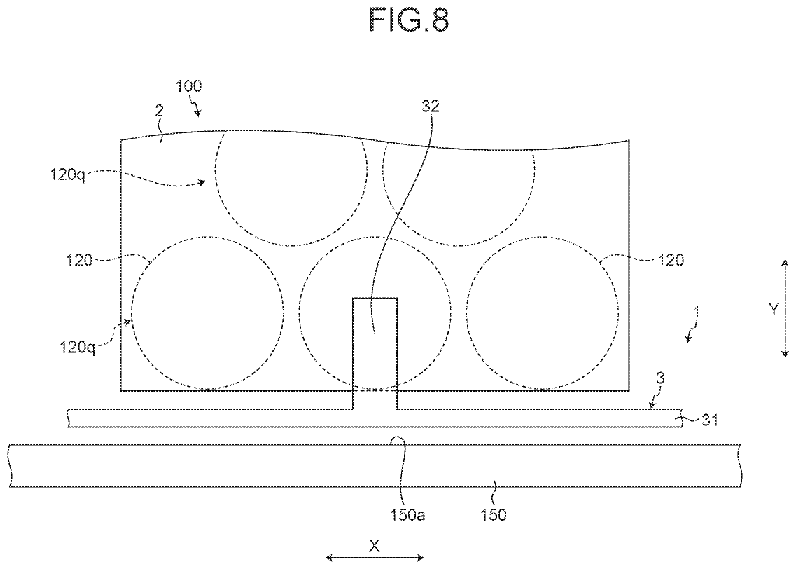

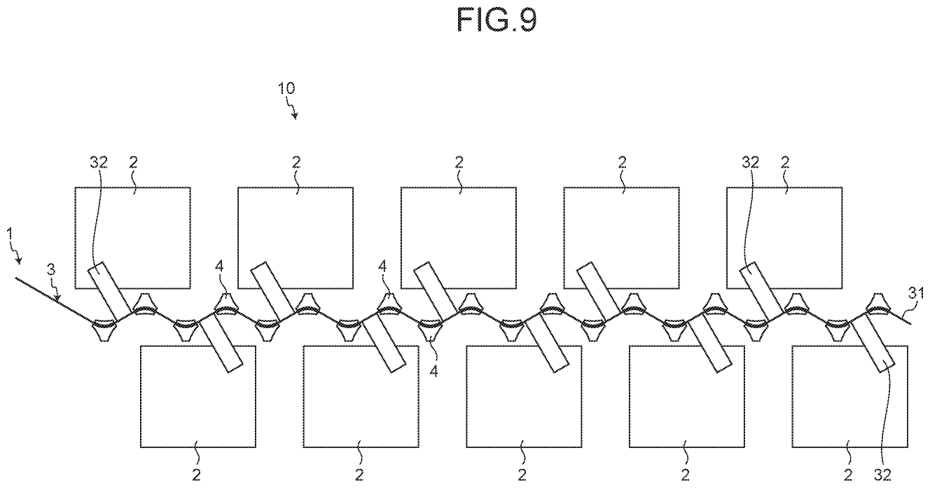

An embodiment will now be explained with reference to FIG. 1 to FIG. 9. The present embodiment relates to a battery pack. FIG. 1 is a perspective view of a battery pack according to the embodiment, FIG. 2 is a perspective view of a substrate module according to the embodiment, FIG. 3 is a plan view of a flexible printed wiring board according to the embodiment, FIG. 4 is a perspective view of a holding member according to the embodiment, FIG. 5 is a perspective view illustrating a mount process of the substrate module to a battery module, FIG. 6 is a plan view of the battery pack according to the embodiment, FIG. 7 is a perspective view of the battery pack according to the embodiment, FIG. 8 is a plan view of the battery pack according to the embodiment, and FIG. 9 is a plan view of a bus bar module according to the embodiment.

As illustrated in FIG. 1, a battery pack 100 according to the present embodiment includes a battery module 110, a plurality of bus bars 2, and a substrate module 1. The battery pack 100 is installed as a power source in vehicles, such as electric vehicles (EVs), hybrid electric vehicles (HEVs), and plug-in hybrid electric vehicles (PHEVs). The battery pack 100 may include a plurality of battery modules 110 and a plurality of substrate modules 1.

The battery module 110 includes a plurality of batteries 120. The batteries 120 are housed in a housing. Each of the batteries 120 is an electric cell that can be charged and caused to discharge electricity. Each of the batteries 120 according to the present embodiment has a cylindrical or columnar shape. Each of the batteries 120 has electrodes 121 on both end surfaces in an axial direction Z thereof. One of the two electrodes 121 is a cathode and the other is an anode.

The battery module 110 includes a plurality of battery rows 120q. One battery row 120q includes a plurality of batteries 120 arranged in a straight line along a first direction X. The battery rows 120q are arranged side by side along a second direction Y. The second direction Y is orthogonal to the first direction X and to the axial direction Z of the batteries 120. The batteries 120 are arranged with outer circumferential surfaces 120a of the batteries 120 facing each other.

The two adjacent battery rows 120q are staggered in the first direction X. The battery rows 120q are arranged such that the batteries 120 form a honeycomb structure, for example. The three batteries 120 adjacent to each other form a triangular prism-shaped space 130.

The bus bars 2 are formed from a conductive metal plate, such as copper and aluminum. Each of the bus bars 2 has, for example, a flat shape. Each of the bus bars 2 illustrated is connected to the electrodes 121 of some of the batteries 120. Each of the bus bars 2 is connected, for example, to the cathodes of the batteries 120. Each of the bus bars 2 according to the present embodiment connects the batteries 120 in parallel.

The substrate module 1 includes a plurality of conductors and connects the bus bars 2 to an external device. The external device is typically a monitoring device that monitors the battery pack 100. The substrate module 1 may be provided with a connector to be connected to an external device. The substrate module 1 includes a flexible printed wiring board 3 and holding members 4.

The flexible printed wiring board 3 is a printed circuit board having flexibility. The flexible printed wiring board 3 includes a resin layer formed of insulating synthetic resin and a plurality of conductors. Each of the conductors is a conductor layer sandwiched between two resin layers and, for example, a metallic foil, such as copper foil. As illustrated in FIG. 2 and FIG. 3, the flexible printed wiring board 3 includes a main body 31 and branch portions 32. The main body 31 and the branch portions 32 are formed as, for example, one unitary piece.

As illustrated in FIG. 3, the main body 31 has a belt-like shape. The main body 31 in plan view has a rectangular shape. The branch portions 32 project from a side 31a extending along a longitudinal direction in the main body 31. The branch portions 32 are connected to the corresponding bus bars 2. Conductors 5 are routed in the main body 31 and the branch portions 32. The branch portions 32 and the conductors 5 are flexible and can be bent with respect to the main body 31. Each of the conductors 5 is a voltage detection line that detects the voltage of the battery 120. One end of each of the conductors 5 is connected to the bus bar 2, and the other end of the conductor 5 is connected to an external device.

The holding members 4 are members that hold the main body 31 of the flexible printed wiring board 3. Each of the holding members 4 is molded from an insulating synthetic resin, for example. The holding members 4 may be formed of elastic deformable material, such as rubber. As illustrated in FIG. 4, each of the holding members 4 has a columnar shape. Each of the holding members 4 is formed such that it can be inserted into the triangular prism-shaped space 130 formed by the batteries 120. Each of the holding members 4 has three facing surfaces 41, three side surfaces 42, a top surface 43, and a bottom surface 44. The top surface 43 and the bottom surface 44 are axial end surfaces in the holding member 4. The facing surfaces 41 and the side surfaces 42 extend along the axial direction of the holding member 4 from the top surface 43 to the bottom surface 44.

Each of the facing surfaces 41 is a surface facing the outer circumferential surface 120a of the battery 120. A cross-sectional shape of the facing surface 41 is an arc shape curved toward a central axis CL of the holding member 4. Each of the side surfaces 42 is a flat surface connecting one facing surface 41 to another facing surface 41.

Each of the holding members 4 includes a slit-shaped recess 45 into which the main body 31 of the flexible printed wiring board 3 is inserted. The shape of the recess 45 as viewed from the direction of the central axis CL is an arc shape curved toward the central axis CL. The recess 45 extends along the central axis CL from the top surface 43 to the vicinity of the bottom surface 44. The recess 45 is opened in each of the two side surfaces 42. The depth of the recess 45 in the axial direction is equal to the width of the main body 31 of the flexible printed wiring board 3. The main body 31 of the flexible printed wiring board 3 is inserted into the recess 45 from a side opposite to the side 31a with the branch portion 32.

As illustrated in FIG. 5, the substrate module 1 is inserted into the battery module 110 along the axial direction Z. The bus bars 2 are fixed in advance to the batteries 120 of the battery module 110. Each of the bus bars 2 is fixed to the electrodes 121 of the batteries 120 by welding or other means. The main body 31 of the flexible printed wiring board 3 is inserted between the two adjacent battery rows 120q. Each of the holding members 4 is inserted into the triangular prism-shaped space 130 formed by the three batteries 120.

FIG. 6 illustrates the substrate module 1 inserted between the two battery rows 120q. The main body 31 of the flexible printed wiring board 3 is routed in a wavy and curved shape with both sides of the main body 31 facing the outer circumferential surfaces 120a of the batteries 120. Each of the holding members 4 inserted into the space 130 can define the curved shape of the main body 31. As illustrated in FIG. 6, the holding members 4 are arranged on both sides of the branch portion 32. The two holding members 4 can hold the main body 31 such that the main body 31 extends in a straight line between the two holding members 4. Each of the holding members 4 is configured, for example, to provide a gap between both sides of the main body 31 and the outer circumferential surfaces 120a of the batteries 120.

Each of the holding member 4 can orient the branch portion 32 and position the branch portion 32 in relation to the bus bar 2. The conductor 5 of the branch portion 32 is connected to the bus bar 2 by welding or soldering. A connector may be provided at the end of the main body 31 for connection to the external device.

When the substrate module 1 is mounted on the battery module 110, resin is injected into the housing of the battery module 110. As the injected resin solidifies, the batteries 120 and the substrate module 1 are fixed in place. The injected resin may be an insulating synthetic resin. The injected resin may function as a heat transfer member to dissipate the heat generated by the batteries 120.

In the battery pack 100 according to the present embodiment, the main body 31 of the flexible printed wiring board 3 is routed along the outer circumferential surfaces 120a of the batteries 120. Thus, the main body 31 can have a width enough for the conductors 5. As a comparative example, considered is a configuration in which the main body of the flexible printed wiring board is routed along the end surfaces of the batteries 120. In this case, the width of the main body of the flexible printed wiring board needs to be narrower to avoid interference with the bus bars 2. As a result, it is necessary to take measures, such as stacking and routing a plurality of flexible printed wiring boards.

In contrast, the battery pack 100 according to the present embodiment eases the restriction on the maximum width of the main body 31 and simplifies the configuration structure. The structure in which the plurality of conductors 5 can be routed in the single main body 31 achieves reduction in cost. The structure in which a sufficient width of the main body 31 is secured suppresses occurrence of circuit resistance problems. The structure in which the main body 31 is routed in the space between the battery rows 120q achieves a lower profile of the battery pack 100. The conductors 5 may be arranged in two separate layers in the main body 31 of the flexible printed wiring board 3.

The main body 31 may be disposed outside the battery rows 120q as illustrated in FIG. 7 and FIG. 8. FIG. 8 illustrates a housing 150 housing therein a plurality of batteries 120. The main body 31 is routed in the gap between an inner wall surface 150a of the housing 150 and the battery row 120q disposed at the end. In this case, the main body 31 can be routed in a straight line along the inner wall surface 150a. The main body 31 may be held between the battery row 120q and the inner wall surface 150a.

As explained above, the battery pack 100 according to the present embodiment includes the cylindrical batteries 120, the bus bars 2, and the flexible printed wiring board 3. The batteries 120 include the electrodes 121 on both end surfaces in the axial direction Z and are arranged with the outer circumferential surfaces 120a of the batteries 120 facing each other. The bus bars 2 are fixed to the electrodes 121. The flexible printed wiring board 3 includes the conductors 5 connected to the bus bars 2.

The flexible printed wiring board 3 includes the belt-like main body 31 and the branch portions 32 projecting from the main body 31. The main body 31 is routed along the outer circumferential surfaces 120a of the batteries 120. The branch portions 32 are connected to the bus bars 2. In the battery pack 100 according to the present embodiment, the belt-like main body 31 is routed along the outer circumferential surfaces 120a of the batteries 120. This structure enables easy arrangement of the required number of conductors 5 in the single main body 31 and simplifies the routing structure of the battery pack 100. This structure enables omission of the case for holding the main body 31, simplifies the configuration of the battery pack 100, and enables low profile of the battery pack 100.

The main body 31 according to the present embodiment is routed in a wavy and curved shape with both sides of the main body 31 facing the outer circumferential surfaces 120a of the batteries 120. The structure in which the main body 31 is routed using the gap between adjacent battery rows 120q enables miniaturization and low profile of the battery pack 100.

The battery pack 100 according to the present embodiment includes the columnar holding members 4 holding the main body 31 of the flexible printed wiring board 3. Each of the holding members 4 includes the slit-shaped recess 45 into which the main body 31 is inserted. Each of the holding members 4 is housed in the triangular prism-shaped space 130 formed by three batteries 120 adjacent to each other to hold the main body 31. The holding members 4 can stabilize the routing shape of the main body 31.

The procedure for mounting the bus bars 2 and the substrate module 1 to the battery module 110 is not limited to the above procedure. For example, as illustrated in FIG. 9, a bus bar module 10 may be formed of the bus bars 2 attached to the substrate module 1. The bus bar module 10 is mounted on the battery module 110. The main body 31 of the flexible printed wiring board 3 is routed along the outer circumferential surfaces 120a of the batteries 120. Therefore, when the bus bars 2 are welded to the electrodes 121 of the batteries 120, the main body 31 does not interfere with the welding operation.

The substrate module 1 may include no holding member 4. When the main body 31 of the flexible printed wiring board 3 is inserted into the gaps between the battery rows 120q, a jig may be used for the insertion operation.

The number of batteries 120 connected to a single bus bar 2 may be any number. The flexible printed wiring board 3 may include conductors 5 that are different from the voltage detection lines. For example, the conductors 5 may include temperature detection lines to detect the temperature. The temperature detection lines may be connected to a thermistor.

The details disclosed in the above embodiment may be used in combination and implemented as appropriate.

The flexible printed wiring board of the battery pack according to the present embodiment includes a belt-like main body routed along outer circumferential surfaces of a plurality of batteries, and branch portions projecting from the main body and connected to bus bars. According to the battery pack of the present embodiment, the belt-like main body is routed along the outer circumferential surfaces of the batteries, and this structure produces the effect of simplifying the routing structure.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a plurality of batteries having a cylindrical shape, arranged with outer circumferential surfaces of the batteries facing each other, and each of the batteries including electrodes on both ends in an axial direction thereof;
a plurality of bus bars fixed to the electrodes; and
a flexible printed wiring board including a plurality of conductors connected to the bus bars, wherein
the flexible printed wiring board includes a belt-like main body routed along the outer circumferential surfaces of the batteries, and branch portions projecting from the main body and connected to the bus bars.

2. The battery pack according to claim 1, wherein
the main body is routed in a wavy and curved shape with both sides of the main body facing the outer circumferential surfaces of the batteries.

3. The battery pack according to claim 2, further comprising:
a columnar holding member holding the main body, wherein
the holding member includes a slit-shaped recess into which the main body is inserted, and is housed in a triangular prism-shaped space formed by three of the batteries adjacent to each other to hold the main body.
